(19) United States
(12) Patent Application Publication
(10) Pub. No.: US 2010/0332877 A1
(43) Pub. Date: Dec. 30, 2010

(54) METHOD AND APPARATUS FOR REDUCING POWER CONSUMPTION

(76) Inventors: Mark A. Yarch, Chandler, AZ (US); Hang Nguyen, Tempe, AZ (US); Sanjeev Jain, Chandler, AZ (US); Shaun Conrad, Cornelius, OR (US)

Correspondence Address: KACVINSKY DAISAK PLLC, C/O CPA Global, P.O. BOX 52050, MINNEAPOLIS, MN, 55402, US

(21) Appl. No.: 12/495,446

(22) Filed: Jun. 30, 2009

(51) Int. Cl. G06F 1/32

(52) U.S. Cl. 713/323; 713/320

(57) ABSTRACT

A system, apparatus, method and article to reduce power consumption are described. The method may include receiving a power management request for a reduced power consumption state from each of a plurality of processors. A power management request for the reduced power consumption state may be sent to a controller to cache data. Each of the plurality of processors may be instructed to enter the reduced power consumption state. An interrupt may be received to return to an active power consumption state. A power management request may be sent to the controller to flush cached data into a memory. Each of the plurality of processors may be instructed to enter the active power consumption state. Other embodiments are described and claimed.

### BACKGROUND

Devices often try to minimize power consumption. The processors of these devices often enter a reduced power consumption state to conserve energy. The reduced power consumption state allows the device to consume less power and remain uninterrupted for a period of time. However, external devices, such as universal serial bus cards and network interface cards, have disrupted the device by waking up the processors each time new data is needed to be placed in memory. As a result, devices with external devices attached have not been optimized due to the external device periodically accessing memory.

### BRIEF DESCRIPTION OF THE DRAWINGS

FIG. 1 illustrates one embodiment of an apparatus.

FIG. 2 illustrates one embodiment of an exemplary logic flow.

FIG. 3 illustrates an exemplary communication diagram for requesting reduced power consumption according to an embodiment.

FIG. 4 discloses an exemplary communication diagram for returning to an active power consumption state according to an embodiment.

FIG. 5 illustrates one embodiment of an exemplary system.

### DETAILED DESCRIPTION

The embodiments are generally directed to techniques for minimizing power consumption. In one embodiment, for example, an apparatus may include a plurality of processors each with an integrated input/output (IIO), a controller and a memory. Each processor with an associated IIO may have a default power consumption state. A first IIO, associated with a first processor, may communicate with the other processors and the controller. When the first IIO receives a request to enter a reduced power consumption state from each of the processors, a power management request for a reduced power consumption state may be sent to the controller. The controller may begin caching incoming data from an external device so that the data is not sent through the processors to the memory. As a result, power consumption is reduced since the processors do not enter the active power consumption state to send the incoming data to the memory. The processors may remain in the reduced power consumption state until one of the processors receives an interrupt. When an interrupt is received, the first IIO may send a message to the controller to flush the data from the cache into the memory. Once the data is sent to the memory, the processors may return to their active power consumption state. In this manner, the processors may remain in a reduced power consumption state and the memory may remain undisturbed by the external device until an interrupt causes the processors to return to the active power consumption state. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

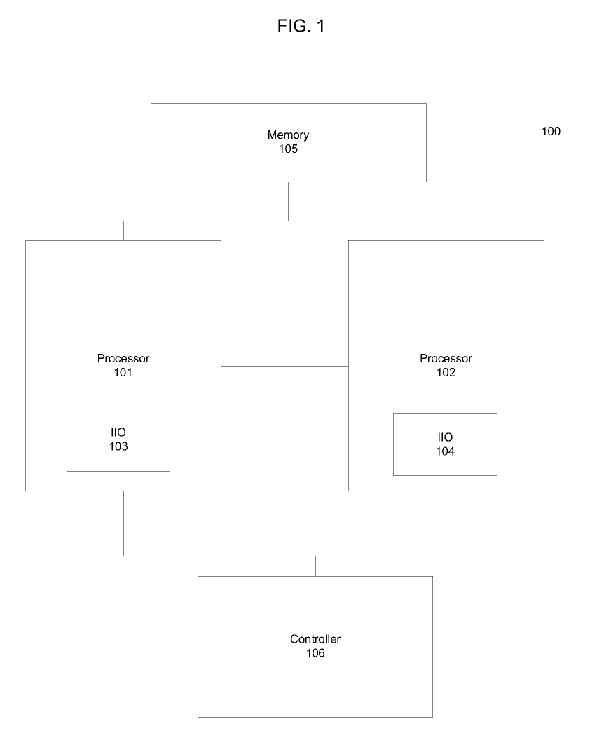

FIG. 1 illustrates an exemplary apparatus that may reduce power consumption. FIG. 1 illustrates a block diagram of an apparatus 100. In one embodiment, the apparatus 100 may include a processing system, a computer, a computer system, a computer sub-system, an appliance, a network application, a workstation, a terminal, a server, a personal computer (PC), a desktop computer, a laptop computer, an ultra-laptop computer, a notebook computer, a handheld computer, a personal digital assistant (PDA), a telephone, a mobile telephone, a cellular telephone, a handset, a smart phone, a pager, a one-way pager, a two-way pager, a digital camera, a digital video recorder, a digital video player, a digital audio recorder, a digital audio player, a set top box (STB), a media server, and so forth. The embodiments, however, are not limited to this example.

As shown in FIG. 1, the apparatus 100 may include multiple elements, such as a first processor 101 with an integrated input/output 103, a second processor 102 with an integrated input/output 104, a memory 105 and a controller 106. The embodiments, however, are not limited to the elements shown in this figure. Although FIG. 1 is shown with a limited number of elements, it may be appreciated that the apparatus 100 may include more elements as desired for a given implementation.

In various embodiments, the apparatus 100 may comprise a plurality of processors 101, 102. While this embodiment is a dual processor system, an alternate embodiment may include a multiprocessor system. The embodiments, however, are not limited to this example. Processors 101, 102 may be implemented using any processor or logic device, such as a central processing unit (CPU), a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 101, 102 may be implemented as a general purpose processor, such as a processor made by Intel® Corporation, Santa Clara, Calif. Processor 101, 102 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

Each processor 101, 102 may operate in various operating modes or states, including one or more power saving or power consumption states, collectively referred to herein as a “low-power processor mode.” For example, processors 101, 102 may operate using the power consumption states as defined by the Advanced Configuration and Power Interface (ACPI) Specification. Examples of operating states may include without limitation those performance states as defined by an ACPI suite of specifications, such as the ADVANCED CONFIGURATION AND POWER INTERFACE SPECIFICATION, Revision 3.0b, Oct. 10, 2006 (the “ACPI Specification”), and its revisions, progeny and variants. The ACPI Specification defines a power management system that allows a computer operation system to control the amount of power consumed by a processor and peripheral devices of the computer system. According to the ACPI Specification, exemplary performance states may comprise global states (e.g., G0-G3), device states (e.g., D0-D3), and processor states (e.g., C0-C7), among others.

The ACPI Specification defines power saving modes C0-Cx, where a Cx state may be used for processor power consumption states. In an embodiment, the power consumption state may be determined with reference to the Cx state. A first Cx state may include a C0 state. The C0 state is when a processor is fully operational and is an active power consumption state. The C0 state may be the default state. In an embodiment, the C3 state is a low power consumption state. The C4 state may be a power consumption state which is less than the C3 state. The lowest power consumption state may be the C7 state. In an embodiment, as the number of the Cx state increases, the power consumption may decrease. Other power saving modes may be implemented for processor 101, 102 as desired for a given implementation.

In an embodiment, a first processor 101 may communicate with a second processor 102 via any bus that allows messages to be sent between the processors. In an embodiment, the first processor may communicate with a second processor via an interconnect such as, but not limited to, quick path interconnect (QPI). An interconnect may be used to connect a processor to one or more other processors, one or more IO hubs or routing hubs in a network. An interconnect may allow all of the components to access other components via the network. Although the interconnect is described as QPI, other suitable interconnects, such as other suitable point-to-point interconnects for example, may be used. The embodiments are not limited in this context.

In an embodiment, each processor 101, 102 may include an integrated input/output (IIO) 103, 104. A first IIO 103 may be associated with a first processor 101. A second IIO 104 may be associated with a second processor 102. The IIOs 103, 104 allow the processor 101, 102 to communicate information to other elements in the apparatus 100.

In various embodiments, the apparatus 100 may comprise a memory 105. Memory 105 may be coupled to the processors 101, 102. In an embodiment, a memory protocol implemented by the processors may be used for the memory and the processors to communicate. For example, the memory and the processor may communicate by a DDR3 protocol. It may be appreciated that the memory and processor may communicate via other protocols as desired for a given implementation. The embodiments are not limited in this context.

Memory 105 may be implemented using any machine-readable or computer-readable media capable of storing data, including both volatile and non-volatile memory. For example, memory 105 may include random-access memory (RAM), dynamic RAM (DRAM), Double-Data-Rate DRAM (DDRAM), synchronous DRAM (SDRAM), static RAM (SRAM) or any other type of media suitable for storing information. It is worthy to note that some portion or all of the memory 105 may be included on the same integrated circuit as processor 101, 102 or alternatively some portion or all of the memory 105 may be disposed on an integrated circuit or other medium, for example a hard disk drive, that is external to the integrated circuit of processor 101, 102. The embodiments are not limited in this context.

In various embodiments, the apparatus 100 may include a controller 106 coupled to a processor 101. The controller 106 may provide for the exchange of information with various external devices through one or more interconnections. The controller 106 may be a southbridge used to connect to lower speed peripheral buses and devices. Examples of a controller 106 include a platform controller hub (PCH). The embodiments, however, are not limited to this example. Although the apparatus is described as using a controller, other suitable communication modules may be used. The embodiments are not limited in this context.

A controller 105 may communicate with an integrated input/output 103 via direct media interface (DMI) or other suitable communication links between an IIO and a controller. DMI allows point-to-point communication between processors and a controller.

In various embodiments, an external device (not shown in FIG. 1) may be connected to the apparatus 100 via the controller 106. The external device may supply additional data to the memory 105 of the apparatus 100. Examples for an external device include Universal Serial Bus (USB) cards, a Peripheral Component Interconnect (PCI) bus, a real time clock, or network interface cards (NICs). The embodiments, however, are not limited to this example.

In general operation, in the apparatus 100, a first integrated input/output 103 associated with a first processor 101 may communicate with the processors 101, 102 and a controller 106. When the first IIO 103 receives a reduced power consumption state request from each of the processors 101, 102, a power management request for the reduced power consumption state may be sent to the controller 106. The power state of the power management request sent to the controller may be the higher power state of the reduced power consumption state requests received from the two processors 101, 102. The controller 106 may begin caching incoming data from an external device. By caching the data, the data does not need to be immediately sent to the memory 105 and the processors 101, 102 may remain in the reduced power consumption state once the controller 106 allows them to enter the reduced state. The processors 101, 102 may remain in the reduced power consumption state until one of the processors 101, 102 receives an interrupt. Once an interrupt is received, the first IIO 103 may send a power management request to the controller 106 to flush the cached data into the memory 105. After the data is received by the memory 105, the processors 101, 102 may return to their active power consumption state. Other embodiments may be described and claimed.

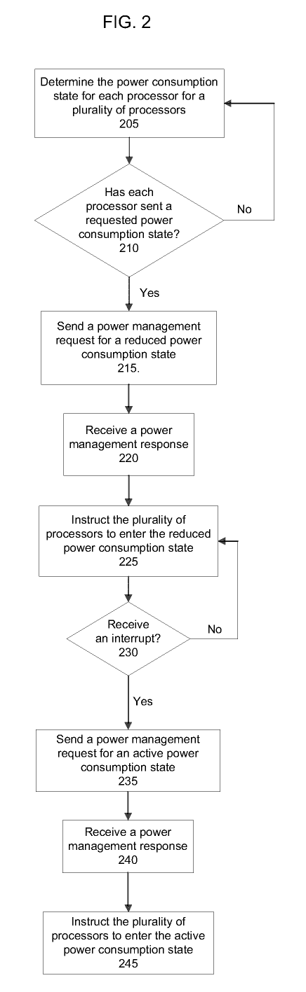

The operations of apparatus 100 may be further described with reference to FIG. 2 and accompanying examples. Although FIG. 2 as presented herein may include a particular programming logic, it can be appreciated that the programming logic merely provides an example of how the general functionality described herein can be implemented. Further, the given programming logic does not necessarily have to be executed in the order presented unless otherwise indicated.

FIG. 2 illustrates a programming logic 200 for reducing the power consumption state of processors according to an embodiment. The logic flow 200 may be representative of the operations executed by one or more embodiments described herein. As shown in the logic flow 200, a first integrated input/output (IIO) associated with a first processor may determine the power consumption state for each processor for a plurality of processors at block 205. In an embodiment, the first IIO associated with a first processor may be the processor coupled to the controller. The other processors with IIOs may communicate with the first processor and the associated first IIO. However, in an embodiment, only the first IIO may communicate directly with the controller. As a result, the controller may only receive communication from a single IIO.

Each processor may operate using the power consumption states as defined by the Advanced Configuration and Power Interface (ACPI) Specification. In an embodiment, the power consumption state may be determined with reference to the package Cx states. In the C0 state, the processor may be fully operational in the active power consumption state. The C0 state may be the default state.

In an embodiment, the first IIO may receive a request for a reduced power consumption state from one or more of the plurality of processors. The processor requesting the reduced power consumption state may broadcast the C state request to all of the other processors. In an embodiment, the first IIO may determine whether each processor sent a power management request for a requested power consumption state request at block 210.

For example, one of the processors may request a power consumption state such as the C3 state. The processor may broadcast the C3 state request to all the other processors and IIOs. However, the first IIO cannot send a power management request to the controller until all the processors have requested a power consumption state. When all of the processors have requested a power consumption state, the first IIO may send a power management request to the controller for a reduced power consumption state at block 215.

In an embodiment, the reduced consumption state requested by a first processor may not be equal to the requested power consumption state sent by a second processor. For example, a first processor may request a C3 state while the second processor may request a lower power consumption state, such as a C6 state. If the processors request different C states, then the first IIO may send a power management request to the controller with the higher power consumption state. Referring to the above example, if the first processor requests a C3 state and the second processor requests a C6 state, the first IIO may send a power management request for a C3 state.

In an embodiment, if the processors request different C states, then the first IIO may send a power management request to the controller with the higher power consumption and lower numerical Cx state. In an embodiment, if the processors request different C states, then the first IIO may send a power management request to the controller with an average of the power consumption states.

The first IIO may receive a power management response from the controller when the controller begins caching data 220. In an embodiment, the controller is coupled to an external device. During an active power consumption state, the external device provides data to the controller which may be sent to the processors and the processors provide the data to the memory. In an embodiment, the processors request a reduced power consumption state. If the controller continues to send the data to the processors, the processor cannot remain in the reduced power consumption state. By caching the data in the controller, the controller retains the data allowing the processors to remain in the reduced power consumption state.

After a power management response is received by the IIO, the first IIO may instruct the plurality of processors to enter the reduced power consumption state at block 225. In an embodiment, the IIO may receive a power management response from the controller after the controller enables data to be cached. The IIO may send a power management request to each of the plurality of processors to enter into the reduced power consumption state. The reduced power consumption state may be entered by initiating requests to enter the reduced power consumption state.

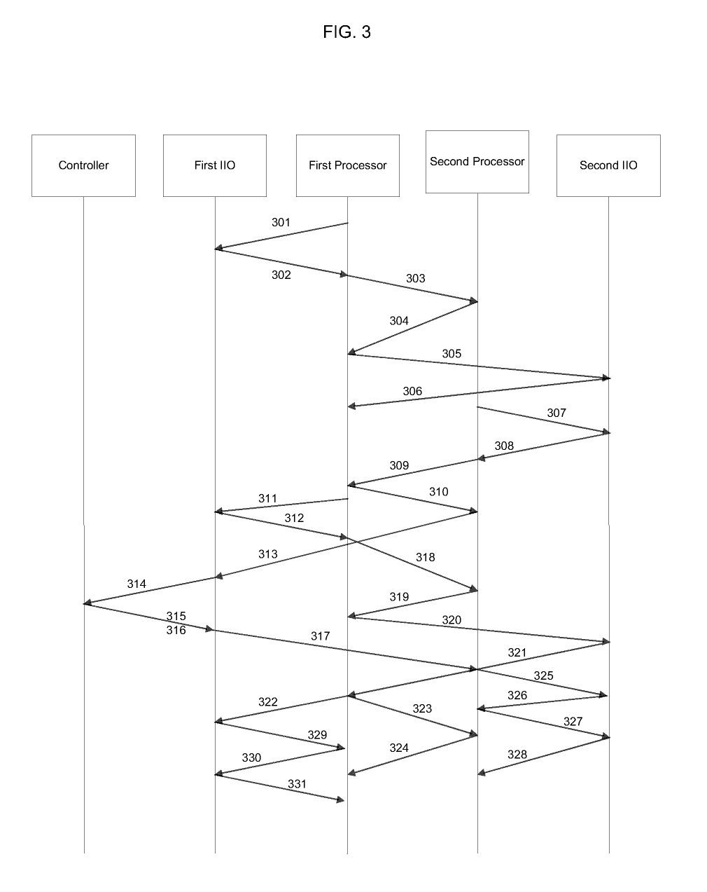

FIG. 3 discloses an exemplary communication diagram of dual processors with integrated input/outputs requesting reduced power consumption according to an embodiment. Although FIG. 3 is shown with a limited number of processors, it may be appreciated that the device may include more processors as desired for a given implementation. Although FIG. 3 is shown with a power management request for a C3 state, it may be appreciated that a different Cx state may be requested as desired for a given implementation. Although FIG. 3 is shown with the first processor sending a power management request, it may be appreciated that a different processor may send a power management request as desired for a given implementation. The embodiments are not limited in this context.

In an embodiment, a first processor may send 301 a power management request for a C3 state to the first IIO. The first IIO may send 302 an acknowledgement of the request and the first processor may broadcast 303 a power management request for a C3 state to a second processor. The second processor may send 304 an acknowledgement to the first processor. The first processor may send 305 a power management request for a C3 state to a second IIO and the second IIO may send 306 an acknowledgement of the request. However, the first IIO may not send a power management request to the controller to enter the reduced power consumption state until the second processor has also requested a reduced power consumption state.

In an embodiment, the second processor may send 307 a power management request to the second IIO for a C3 state. The second IIO may return 308 an acknowledgement of the request. The second processor may send 309 a power management request for a C3 state to the first processor. The first processor may send 310 an acknowledgement to the second processor.

The power management request from the second processor may trigger the first processor to re-send 311, a second request for a C3 state, to the first IIO. The first IIO may send 312 an acknowledgement to the first processor that the first processor can enter a C3 state. The second processor may send 313 a power management request for a C3 state to the first IIO. Since both the first processor and the second processor sent a power management request for a C3 state, the first IIO may send 314 a power management request for a C3 state to the controller.

The controller may send 315 a response to the first IIO and begin caching 316 data received from an external device. The first IIO may send 317 an acknowledgement of the earlier request 313 to the second processor.

Concurrently, after an acknowledgement is received 312 from the first IIO to the first processor in response to the triggering event, the first processor may send 318 a power management request for a C3 state to the second processor. The second processor may acknowledge 319 the request. The first processor may send 320 a power management request for a C3 state to the second IIO which the second IIO may acknowledge 321. After the acknowledgement 321 is received by the first processor, the first processor may send 322 a request to initiate the reduced power consumption C3 state to the first IIO and may send 323 a request to initiate the reduced power consumption C3 state at the second processor. In an embodiment, the first processor may initiate the power consumption request for the C3 state after receiving an acknowledgement from the first ITO. The second processor may send 324 an acknowledgement of the request and the first processor may enter the reduced power consumption C3 state.

Meanwhile, after the second processor receives 317 an acknowledgement, the second processor may send a request 325 to initiate the reduced consumption C3 state to the second IIO. The second IIO may send 326 a non-acknowledgement response if the second IIO is not ready to enter the low power state. The second processor may send 327 another request to initiate the reduced power consumption C3 state to the second IIO. The second IIO may send 328 an acknowledgement of the request when it is ready to enter the low power state and the second processor may enter the reduced power consumption C3 state.

When the first processor sends 322 a request to initiate the reduced power consumption C3 state to the first IIO, the first IIO may send 329 a non-acknowledgement response. The first IIO may continue to send non-acknowledgement responses to the first processor's requests 322, 330 until the activity time expires and the processor receives an interrupt 331 to return to the active power consumption state.

Referring back to FIG. 2, the device may remain in the reduced power consumption state until an interrupt is received at block 230. An interrupt or other suitable methods to trigger an exit from the reduced power consumption state may be received. In an embodiment, an interrupt may be a request for a processor to return to an active power consumption state. In an embodiment, an interrupt may be received after a period of time.

Once a processor receives an interrupt, that processor will broadcast the active state power consumption request to all the other processors and IIOs. When the first IIO receives the interrupt, a power management request may be sent to the controller that one or more processors are resuming an active power consumption state at block 235. After receiving the power management request, the controller may flush the data in the cache to the memory. The data in the cache is flushed to the memory prior to the processors returning to the active power consumption state. By providing the memory with the data in the cache before the processor resumes the active power consumption state, data consistency is ensured. In an embodiment, even if only one processor is returning to the active power consumption state, the controller flushes the data from the cache into the memory prior to the processor entering the active power consumption state.

After the data in the cache is flushed, the controller may send a power management response. The first IIO may receive a power management response from the controller at block 240. The first IIO may instruct the plurality of processors to enter the active power consumption state at block 245. Prior to instructing the processors to enter the active power consumption states, a response from the controller may be received after the data in the cache was flushed to memory. A power management request may be sent to each of the plurality of processors to enter into the active power consumption state.

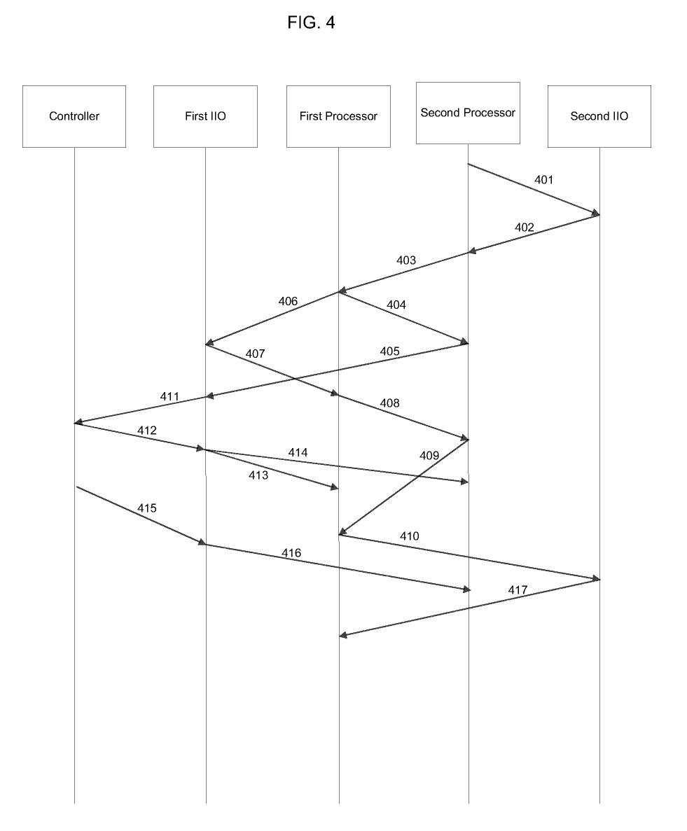

FIG. 4 discloses an exemplary communication diagram of dual processors with integrated input/outputs returning to an active state according to an embodiment. In an embodiment, a processor may receive an interrupt. In an embodiment, a processor which receives an interrupt may broadcast the interrupt to all of the other processors and IIOs. In an embodiment, a second processor may receive an interrupt. The second processor may send 401 a power management request to return to the active power consumption C0 state to the second IIO. The second IIO may send 402 an acknowledgement to the second processor. The second processor may send 403 a power management request for the C0 state to the first processor. The first processor may respond 404 with an acknowledgment stating that the first processor will remain in the reduced power consumption C3 state. The second processor may send 405 a power management request to return to the active power consumption C0 state to the first IIO.

Additionally, in response to the first processor's acknowledgement 404, the first processor may send 406 a request to remain in the reduced power consumption state C3 to the first IIO. The first IIO may send 407 an acknowledgement regarding the C3 state. The first processor may send 408 a power management request to remain in the reduced power consumption state C3 to the second processor. The second processor may respond 409 with an acknowledgement of the active power consumption state C0.

Concurrently, after the second processor sends 405 a power management request to the first IIO for an active power consumption C0 state, the first IIO may send 411 to the controller a power management request to return to the active power consumption C0 state. The controller may flush 412, 413, 414 the data from the cache into the memory. After all the data in the cache is flushed into the memory, the controller may send 415 a power management response to the first ITO. The first IIO may send 416 an acknowledgement to the second processor's power management request 405 for active power consumption C0 state. After the acknowledgement is sent 416, the processors can access the data in the memory. The acknowledgement may cause the second processor to return to the active power consumption C0 state. In an embodiment, the request sent 410 from the first processor to the second IIO to remain in the reduced power consumption state C3, may be sent 417 an acknowledgement. The first processor may return to the active power consumption C0 state. Once one of the processors wakes up, the other processors may also wake up since all the processors are needed to do snoops on the cache and access the memory controller. In an embodiment, the processor may wake-up but cores inside the processor do not need to wake up.

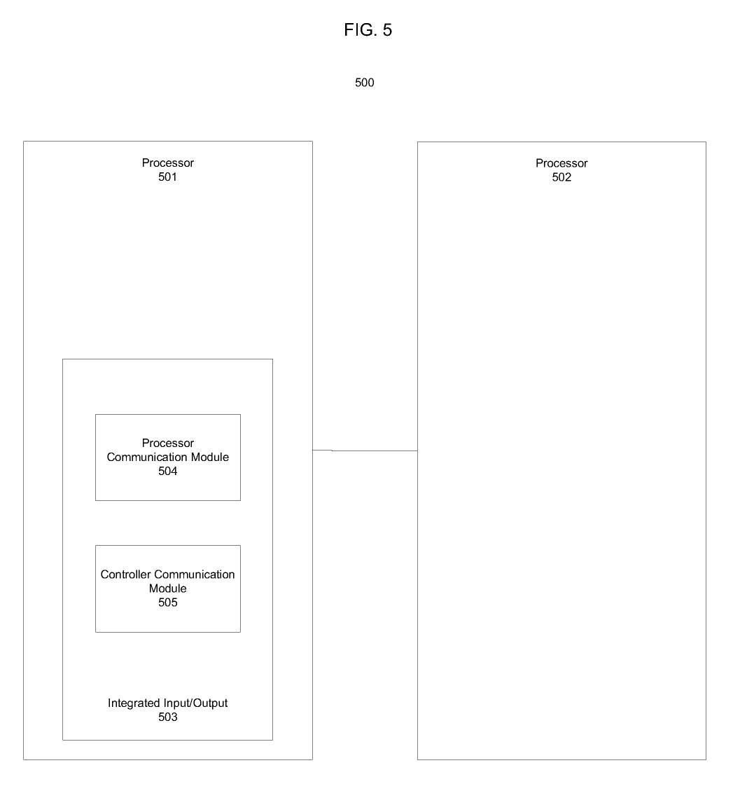

FIG. 5 illustrates one embodiment of a system. FIG. 5 illustrates a system 500. System 500 may be representative of a system or architecture suitable for use with one or more embodiments described herein, such as apparatus 100, logic flow 200, and so forth.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

In various embodiments, system 500 may include a plurality of processors 501, 502, wherein one processor 501 from the plurality of processors comprises an integrated input/output 503. The integrated input/output 503 may include a processor communication module 504 and a controller communication module 505. In an embodiment, one or more of the processors may be coupled to a heat sink.

In an embodiment, a processor communication module 504 may be configured to determine whether each of the plurality of processors requested a reduced power consumption state. In an embodiment, the processor communication module 504 may be configured to instruct each of the plurality of processors to enter into a reduced power consumption state. In an embodiment, the processor communication module 504 may be configured to instruct each of the plurality of processors to return to an active power consumption state.

The controller communication module 505 may be configured to send a power management request for the reduced power consumption state. The controller communication module 505 may be configured to receive a power management response for the reduced power consumption state. In an embodiment, the controller communication module 505 may be configured to send a power management request for an active power consumption state. In an embodiment, the controller communication module 505 may be configured to receive a power management response for an active power consumption state.

The system may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner.

In general operation, in the system 500, a processor communication module 504 in an IIO 503 may receive a reduced power consumption state request from each of the processors 501, 502. The controller communication module 505 in the IIO 503 may send a power management request for the reduced power consumption state. The processor communication module 504 in the IIO 503 may receive an interrupt. The controller communication module 505 may send a power management request. Once a response to the power management request is received by the processors 501, 502, the processors 501, 502 may return to their active power consumption state. Other embodiments may be described and claimed.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. sctn. 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving a power management request for a requested power consumption state from each of a plurality of processors;
sending a power management request for a reduced power consumption state to a controller to cache data based on the requested power consumption states;
instructing each of the plurality of processors to enter the reduced power consumption state;
receiving an interrupt to return to an active power consumption state;
sending a power management request to the controller to flush the cached data into a memory; and
instructing each of the plurality of processors to enter the active power consumption state.

2. The method of claim 1 further comprising:
determining a power consumption state for each of the plurality of processors, wherein each processor has a default power consumption state.

3. The method of claim 1 wherein said instructing each of the plurality of processors to enter the reduced power consumption state comprises:
receiving a power management response from the controller after the controller enables data to be cached; and
sending a power management request to each of the plurality of processors to enter the reduced power consumption state.

4. The method of claim 1 wherein said instructing each of the plurality of processors to enter an active power consumption state comprises:
receiving a response from the controller after the data in the cache was flushed to memory;
sending a power management request to each of the plurality of processors to enter the active power consumption state.

5. The method of claim 1 wherein said receiving a power management request comprises receiving a power management request via a point-to-point interconnect.

6. The method of claim 1 wherein said sending a power management request for a reduced power consumption state to a controller comprises sending a power management request for a reduced power consumption state via direct media interface communication.

7. The method of claim 1 wherein:
said receiving a power management request for a requested power consumption state from each of a plurality of processors comprises:
receiving a first power consumption state from a first processor, and
receiving a second power consumption state from a second processor; and
said sending a power management request for a reduced power consumption state to the controller to begin caching data based on the requested power consumption states comprises:
sending the second power consumption state to the controller as the reduced power consumption state if the first power consumption state is less than the second power consumption state, and
sending the first power consumption state to the controller as the reduced power consumption state if the first power consumption state is greater than the second power consumption state.

8. The method of claim 1 wherein the power consumption state is a state defined by an Advanced Configuration and Power Interface (ACPI) Specification.

9. An apparatus, comprising:
a first processor configured to enter a reduced power consumption state, the first processor comprising an integrated input/output configured to:
receive a power management request for the reduced power consumption state,
instruct the first processor to enter the reduced power consumption state,
receive an interrupt to return to an active power consumption state, and
instruct the first processor to enter the active power consumption state.

10. The apparatus of claim 9, further comprising:
a second processor with an integrated input/output coupled to the first processor via a point-to-point interconnect, wherein the second processor sends a power management request for the reduced power consumption state.

11. The apparatus of claim 9, further comprising:
a second processor with an integrated input/output coupled to the first processor via a point-to-point interconnect; and
a third processor with an integrated input/output coupled to the first processor via a point-to-point interconnect.

13. The apparatus of claim 9 further comprising:
a memory coupled to the first processor, the memory configured to store data.

12. The apparatus of claim 9 further comprising:
a controller coupled to the first processor via a direct media interface communication.

14. The apparatus of claim 12, further comprising:
an external device coupled to the controller.

15. A system comprising:
a plurality of processors, wherein one processor from the plurality of processors comprises an integrated input/output including:
a processor communication module configured to determine whether each of the plurality of processors requested a reduced power consumption state, and
a controller communication module to send a power management request for the reduced power consumption state and send a power management request for an active power consumption state upon receiving an interrupt; and
a heat sink coupled to one or more of the plurality of processors.

16. The system of claim 15 wherein the process communication module is further configured to:
instruct each of the plurality of processors to enter into a reduced power consumption state.

17. The system of claim 15 wherein the process communication module is further configured to:
instruct each of the plurality of processors to return to an active power consumption state.

18. The system of claim 15, further comprising:
a controller configured to:
receive the power management request for the reduced power consumption state,
store data in a cache,
receive the power management request for the active power consumption state, and
release the data from the cache.

19. The system of claim 15 wherein the plurality of processors comprises two processors.

20. The system of claim 15 wherein the plurality of processors comprises four processors.

21. An article comprising a machine-readable storage medium containing instructions that if executed enable a system to:
receive a power management request for a reduced power consumption state from each of a plurality of processors;
send a power management request for the reduced power consumption state to the controller to begin caching data;
enter the reduced power consumption state.

22. The article of claim 21 further comprising instructions that if executed enable a system to:
receive an interrupt to return to an active power consumption state;
send a power management request to the controller to flush cached data into a memory; and
enter the active power consumption state.

23. The article of claim 21 further comprising instructions that if executed enable a system to:
determine a power consumption state for each of the plurality of processors, wherein each processor has a default power consumption state.

24. The article of claim 21 wherein said instructions that if executed enable a system to instruct the plurality of processors to enter the reduced power consumption state comprise instructions that if executed enable a system to:
receive a power management response from the controller after the controller enables data to be cached; and
send a power management request to each of the plurality of processors to enter into the reduced power consumption state.

25. The article of claim 21 wherein said instructions that if executed enable a system to instruct the plurality of processors to enter an active power consumption state comprise instructions that if executed enable a system to:
receive a response from the controller after the data in the cache was flushed to memory, and
send a power management request to each of the plurality of processors to enter into the reduced power consumption state.

26. The article of claim 21 wherein the reduced power consumption state is state C3, as defined by an Advanced Configuration and Power Interface (ACPI) Specification.

27. The article of claim 21 wherein said instructions if executed enable a system to receive a power management request from a processor comprises instructions that if executed enable a system to:
receive a power management request from a processor via a point-to-point interconnect.

28. The article of claim 21 wherein said instructions that if executed enable a system to send a power management request to a controller comprises wherein said instructions that if executed enable a system to:
send a power management request to a controller via direct media interface communication.

29. The article of claim 21 wherein said instructions that if executed enable a system to
receive a power management request for a reduced power consumption state from each of a plurality of processors comprise instructions that if executed enable a system to:
receive a first power consumption state from a first processor, and
receive a second power consumption state from a second processor; and
send a power management request for the reduced power consumption state to the controller to begin caching data comprise instructions that if executed enable a system to:
send the second power consumption state to the controller as the reduced power consumption state if the first power consumption state is less than the second power consumption state, and
send the first power consumption state to the controller as a reduced power consumption state if the first power consumption state is greater than the second power consumption state.
